(19) United States
(12) Patent Application Publication
(10) Pub. No.: US 2013/0256425 A1
(43) Pub. Date: Oct. 3, 2013

(54) SELF CLEANING EDUCTOR

(71) Applicants: Alfonso M. Misuraca, SR., Somerset, NJ (US); Alfredo P. Morales, Carteret, NJ (US)

(72) Inventors: Alfonso M. Misuraca, SR., Somerset, NJ (US); Alfredo P. Morales, Carteret, NJ (US)

(21) Appl. No.: 13/430,931

(22) Filed: Mar. 27, 2012

(51) Int. Cl. B05B 15/00

(52) U.S. Cl. 239/10; 239/106

(57) ABSTRACT

The present invention relates to a self cleaning eductor that uses the same fluid to provide the primary pumping action and to continuously clean the throat of the eductor. Dry particles are suctioned into the eductor and suspended within a fluid for transporting the particles within the eductor. Material cleaned off the eductor throat is discharged through a diffuser of the eductor along with the pumped material. Particles enter the tubular body through a tube positioned at a shallow angle relative to the fluid jet stream.

### BACKGROUND OF THE INVENTION

1. Field of the Invention

The present invention relates to a self cleaning eductor in which the assembly provides suctioning, dispersing and hydrating of dry particles using the same fluid to provide the primary pumping action and to clean the eductor.

2. Description of Related Art

Pumping ejectors which use entrainment fluids for another fluid to be pumped are known. U.S. Pat. No. 4,184,806 describes a pumping ejector having a fixed tubular ejector body passing through the wall of a protective cell. The body that projects into the cell has an extension provided with a first lateral connection for the admission of a pumping steam flow, a second lateral connection connected to a pipe for admitting a fluid to be pumped and an axial diffuser for the outflow of said fluid shaped in convergent-divergent manner and fitted into the body behind the diffuser. When a blockage occurs, either in the intake pipe or in the diffuser or beyond the latter, a tube carrying a nozzle is brought into contact with the diffuser and completely sealing in the manner of a needle valve the passage left free in normal operation between the intake pipe and the diffuser. In this sealing position, the flow of steam introduced into the tube towards the nozzle is directly passed into the diffuser in order to ensure the unblocking of the latter or of the pipe located downstream. In the same way, the separate steam flow supplied to the ejector body by a third connection is passed in the reverse direction and independently of the main flow in the nozzle into the intake pipe which also brings about the unblocking of the latter.

U.S. Pat. No. 4,396,355 describes an ejector having an additional nozzle for issuing a fluid at a relatively high pressure through a throat of the ejector into an outlet from the throat, so as to clear any material lodging in the outlet and/or the throat. The additional nozzle may be co-axial with the main nozzle of the ejector, or angularly disposed from it. A clear fluid is intermittently introduced from a supply into the additional nozzle at high pressure to break up or dislodge material lodging in the outlet and/or the throat.

The above-described patents describe using a fluid other than the fluid that provides the primary pumping action to clean the eductor throat. It is desirable to provide a self cleaning eductor that uses the same fluid to provide the primary pumping action to continuously clean the throat of the eductor.

### SUMMARY OF THE INVENTION

The present invention relates to a self cleaning eductor that uses the same fluid to provide the primary pumping action and to continuously clean the throat of the eductor. Dry particles are suctioned into the eductor and suspended within a fluid for transporting the particles within the eductor. For example, the fluid can be water which also can be used to hydrate the particles. Suitable particles include polymer particles and flocculants. Material cleaned off the eductor throat is discharged through the diffuser of the eductor along with the pumped material.

Fluid enters as a fluid jet stream from a nozzle positioned within a tubular body of the eductor. Particles enter the tubular body through a tube positioned at a shallow angle relative to the fluid jet stream. The angle is selected to be a shallow angle to provide enhanced merging of particles into the fluid jet stream. Preferably, the angle is in the range of about 20 degrees to about 30 degrees. The diameter of the tube is determined by the suction vacuum generated by the fluid jet stream in order to allow the particles to have a high velocity as they enter the fluid jet stream for enhanced dispersion of the particles within the fluid jet stream. Apertures send sprays of the pumping fluid, water, within the tubular body at the position where the dry particles and the fluid jet stream are combined for continuously flushing the walls of the tubular body in order to scrub any dry particles off the eductor cavity before the particles can build up.

The invention will be more fully described by reference to the following drawings.

### BRIEF DESCRIPTION OF THE DRAWINGS

FIG. 1 is a schematic diagram of a self-cleaning eductor in accordance with the teachings of the present invention.

FIG. 2 is a schematic diagram of the self-cleaning eductor including flow of fluid and particles.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

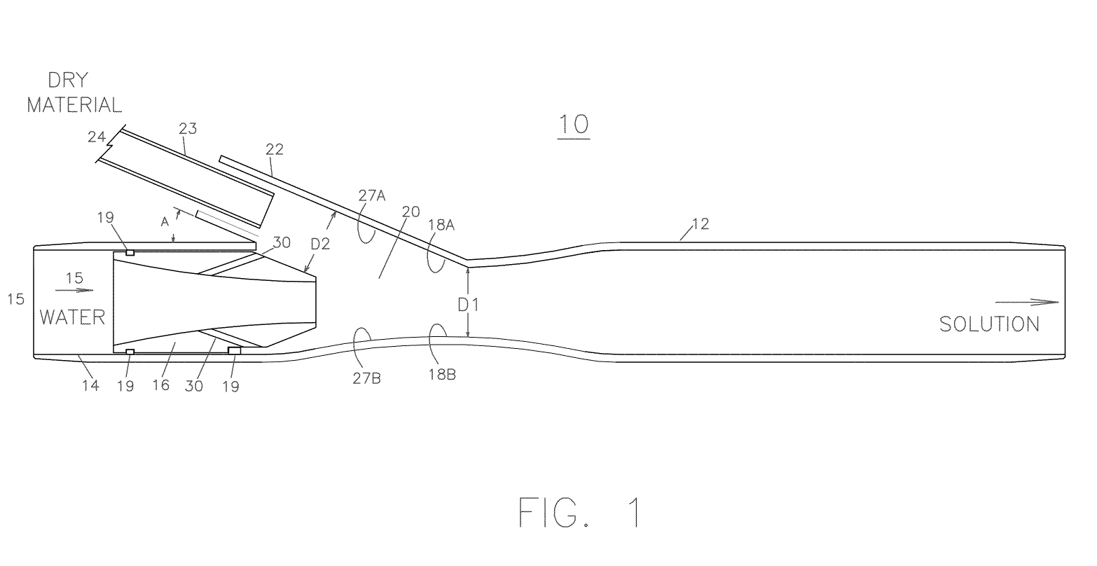

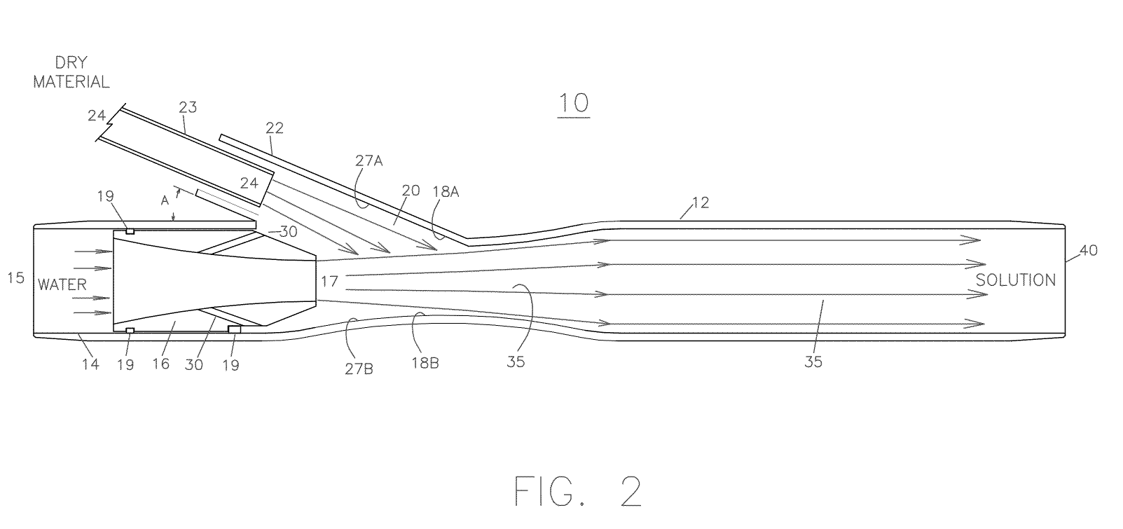

FIGS. 1 and 2 are schematic diagrams of self-cleaning eductor 10 in accordance with the teachings of the present invention. Self-cleaning eductor 10 includes tubular body 12. Tubular body 12 can be referred to as the throat of self-cleaning eductor 10. Inlet tubular portion 14 extends from tubular body 12. Inlet tubular portion 14 receives fluid 15. For example, fluid 15 can be water or another fluid suitable for suspending particles therein.

Fluid 15 enters nozzle 16 positioned within tubular body 12. Nozzle 16 can be used to accelerate the velocity of fluid 15 to a predetermined velocity. For example the velocity can be in the range of about 50 feet per second to about 80 feet per second. The velocity is selected to be low enough such that fluid jet stream 17 exiting nozzle 16 immediately begins to expand towards inner surfaces 18a, 18b of tubular body 12 and high enough such that a suction vacuum is provided within tube 23. Nozzle 16 can be mounted within inlet tubular portion 14 using pins 19. It will be appreciated that other mounting devices known to one of ordinary skill in the art can be used for mounting nozzle 16. Diameter D₁ of tubular body 12 extending at exit portion 20 after nozzle 16 can be tapered to substantially match the profile of expanding fluid jet stream 17 entering exit portion 20, as shown in FIG. 2.

Referring to FIG. 1, inlet tubular portion 22 extends from tubular body 12 adjacent nozzle 16. Tube 23 extends into inlet tubular portion 22. Tube 23 receives particles 24. Particles 24 can be of any material in powder or granulated form. For example, particles 24 can be spheres having a diameter in the range of about 1/64 inch to about ⅛ inch. Suitable particles 24 include polymer particles and flocculants. Inlet tubular portion 22 is brought at angle A between inlet tubular portion 14 and inlet tubular portion 22. Angle A is selected to be a shallow angle to provide enhanced merging of particles 24 into fluid jet stream 17. Preferably, angle A is in the range of about 20 degrees to about 30 degrees.

Diameter D₂ of inlet tubular portion 22 is selected to allow particles 24 to be drawn by the suction vacuum generated by fluid jet stream 17. Diameter D₂ is selected to allow particles 24 to have a high velocity as they enter fluid jet stream 17 for enhanced dispersion of particles 24 within fluid jet stream 17. In one embodiment, Diameter D₂ is in the range of about ¾ inch to about 1¼ inch and Diameter D₁ is in the range of about 1 inch to about 1½ inch. Angle A is selected to reduce the number of particles that pass around fluid jet stream 17 and impinge on inner surfaces 18a,18b of tubular body 12.

Apertures 30 are positioned along the nozzle 16. Apertures 30 supply streams of fluid to continuously flush inner surfaces 18a, 18b, 27a, 27b of exit portion 20.

Particles 24 are dispersed into fluid jet stream 17 to form mixture 35. Mixture 35 exits eductor 10 through exit tubular portion 40.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A self-cleaning eductor comprising:
a tubular body;
a first inlet tubular portion extending axially from an end of the tubular body and an exit tubular portion extending from the other end of the tubular body;
a nozzle positioned within the inlet tubular portion; and
a second inlet tubular portion extending at an angle from the first inlet tubular portion,
wherein the first inlet tubular portion is adapted to receive a fluid and the nozzle accelerates the velocity of the fluid to provide a fluid jet stream and a suction vacuum within and adjacent the nozzle and the second inlet tubular portion is adapted to receive a plurality of particles which are dispersed into the fluid jet stream, the resulting mixture of the particles and the fluid jet stream exiting the eductor through the exit tubular portion, whereby the fluid jet stream provides pumping action and continuously cleans the inner surface of the tubular body.

2. The eductor of claim 1 wherein the angle is in the range of about 20 degrees to about 30 degrees.

3. The eductor of claim 1 wherein the nozzle accelerates the velocity of the fluid to a range of about 50 feet per second to about 80 feet per second.

4. The eductor of claim 1 wherein the diameter of the tubular body extending after the nozzle is tapered.

5. The eductor of claim 1 wherein a tube is positioned within the second tubular portion, the tube receiving the particles.

6. The eductor of claim 1 wherein the particles are polymer particles and the fluid is water.

7. The eductor of claim 1 wherein the particles are spheres having a diameter in the range of about 1/64 inch to about ⅛ inch.

8. The eductor of claim 1 further comprising apertures positioned along the nozzle for supplying streams of the fluid to continuously flush the inner surfaces of the second inlet tubular portion.

9. The eductor of claim 1 further comprising apertures positioned along the nozzle, the apertures adapted for supplying a stream of fluid to continuously flush the inner surfaces of the tubular portion after the nozzle.

10. A method for self-cleaning of an eductor comprising:
providing an eductor comprising a tubular body; a first inlet tubular portion extending axially from an end of the tubular body and an exit tubular portion extending from the other end of the tubular body; a nozzle positioned within the inlet tubular portion; and a second inlet tubular portion extending at an angle from the first inlet tubular portion,
receiving a fluid in the first inlet tubular portion; accelerating the velocity of the fluid with the nozzle to provide a fluid jet stream and a suction vacuum within and adjacent the nozzle; receiving a plurality of particles in the second inlet tubular portion which are dispersed into the fluid jet stream, wherein the resulting mixture of the particles and the fluid jet stream exits the eductor through the exit tubular portion, whereby the fluid jet stream provides pumping action and continuously cleans the inner surface of the tubular body.

11. The method of claim 10 wherein the angle is in the range of about 20 degrees to about 30 degrees.

12. The method of claim 10 wherein the nozzle accelerates the velocity of the fluid to a range of about 50 feet per second to about 80 feet per second.

13. The method of claim 10 wherein the diameter of the tubular body extending after the nozzle is tapered.

14. The method of claim 10 wherein a tube is positioned within the second tubular portion, the tube receiving the particles.

15. The method of claim 10 wherein the particles are polymer particles and the fluid is water.

16. The method of claim 10 wherein the particles are spheres having a diameter in the range of about 1/64 inch to about ⅛ inch.

17. The method of claim 10 further comprising apertures positioned along the nozzle, the apertures adapted for using the primary pumping fluid to supply a stream of fluid to flush the inner surfaces of the second inlet tubular portion.

18. The method of claim 10 further comprising apertures positioned along the nozzle, the apertures adapted for using the primary pumping fluid to supply a stream of fluid to flush the inner surfaces of the tubular portion after the nozzle.
